(19) United States
(12) Patent Application Publication
(10) Pub. No.: US 2021/0104243 A1
(43) Pub. Date: Apr. 8, 2021

(54) AUDIO RECORDING METHOD WITH MULTIPLE SOURCES

(71) Applicant: Steven N. Verona, Bay Harbor, FL (US)

(72) Inventor: Steven N. Verona, Bay Harbor, FL (US)

(21) Appl. No.: 17/063,100

(22) Filed: Oct. 5, 2020

Related U.S. Application Data
(60) Provisional application No. 62/910,847, filed on Oct. 4, 2019.

(51) Int. Cl. G10L 15/26; G10L 25/51; G08B 21/18

(52) U.S. Cl. CPC G10L 15/26; G08B 21/182; G10L 25/51

(57) ABSTRACT

A method and apparatus for recording speech from more than one speaker, and producing a human-perceptible alert when more than one speaker speaks for longer than a predetermined time. The speech may be transcribed by a human operator, or by digital means, such as voice-recognition transcription software. The recorded data may also be processed to make it more readily manually or digitally transcribed, such as by creating separate speech tracks when simultaneous speech is detected, whether by separate microphones, video data indicating two speakers speaking simultaneously, or other means. The recorded data may be time-stamped and rendered unchangeable to maintain the integrity of the data.

### BACKGROUND OF THE INVENTION

Court reporters traditionally record people speaking. More recently, depositions and trials have been recorded using audio and video that is later transcribed into written text. One of the most difficult events for court reporters to transcribe is more than one person speaking at a time. There is a need to distinguish between two or more speakers in order to obtain a suitable record of a deposition, trial or any other situation in which multiple speakers may be speaking at different times or the same time. This is also helpful in other contexts, such as during conferences with multiple parties who are connected by telephone, computer or any other means.

### BRIEF SUMMARY OF THE INVENTION

Disclosed herein is a method and an apparatus for recording multiple speakers by audio and/or video recording. If multiple speakers are speaking simultaneously, this is detected by the apparatus, and, if this occurs for longer than a predetermined time, such as two seconds, a notification is given, either to one or more of the speakers or to someone other than the speakers. The notification allows or causes the multiple, simultaneous speakers to halt speaking simultaneously and re-state their spoken words separately. The person (or apparatus for) transcribing the spoken words may transcribe the audio and/or video separately, regardless of whether the speakers re-state their spoken words.

In an embodiment, there is at least one microphone, and preferably as many microphones as human speakers. In a preferred embodiment, there is an omnidirectional microphone to record sound from the entire environment. Further, there is an apparatus to record the spoken words, which apparatus may be in the vicinity of the potential speakers or may be remote from the speakers. There may optionally be one video recording apparatus and still further there may be multiple video recording apparatuses, such as one for each potential speaker. There is preferably software that is programmed to cause a computer to detect the characteristics of each recorded voice in order to determine which speaker is speaking at any time. The software may optionally utilize the data received from the video recording apparatus to cause the computer to determine the speaker who is speaking, working in conjunction with the audio data.

Thus, it is possible to transcribe using audio and/or video (and possibly other) data collected from one or more speakers in a room, such as a courtroom or conference room being used for a deposition, or in the vicinity of the microphones or other electromechanical transducers that can detect sound waves and/or light waves.

### BRIEF DESCRIPTION OF THE SEVERAL VIEWS OF THE DRAWINGS

FIG. 1 is a schematic view illustrating an embodiment of the present invention.

FIG. 2 is a schematic view illustrating another embodiment of the present invention

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

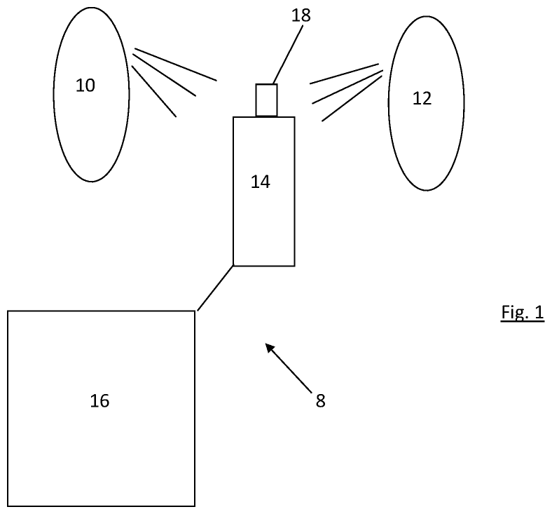

An apparatus 8 is disclosed herein and shown in FIG. 1 for recording audio and/or video data and transcribing into digital or printed text the words spoken by one or more human speakers. The text may be a digital file that contains, for example, the text in an ASCII character set or other form. In one example, a digital file is created that is structured as a sequence of lines of electronic text. Printed text may include English or other language letters, words, symbols, raised Braille characters and other written communication means on paper or other physical structures that are perceptible by human senses.

The apparatus 8 includes at least one microphone 14, at least one audio recording device 16, and at least one human-perceivable notification means 18. The notification means may be a chime or siren, a light, or may be any other device that produces a signal that humans can perceive. Two human speakers 10 and 12 may be adjacent the apparatus 8. There may be more than two human speakers, in any quantity that may be recorded by the apparatus 8. In the example of FIG. 1, which is illustrative, two speakers 10 and 12 may speak, thereby creating sound waves that move at least toward the microphone 14. The microphone 14 receives the sound waves made by the speakers 10 and 12 and transduces them into electrical signals or an equivalent form of data. Those signals are transmitted, such as by wire but alternatively wirelessly, to the device 16 that records the data.

The device 16, or another device (not shown), may have software and a computer for receiving the data and, in real time, analyzing the data to determine whether more than one speaker is speaking simultaneously. The computer may be a programmable computer, such as a tablet, smartphone, personal computer, mainframe computer, or a logic circuit. The computer may operate using software that analyzes signals from the microphones and other inputs, which software is programmed to detect when a speech signal is emanating from more than one of the inputs simultaneously. If such simultaneous speaking occurs for more than a predetermined amount of time, a notification is given using the notification means 18. The predetermined amount of time may be a fraction of a second, such as 0.01 second, or it may be multiple seconds, such as two seconds. The predetermined amount of time may be any fraction of a second, such as 0.1, 0.2, 0.3, 0.4, 0.5, 0.6, 0.7, 0.8 or 0.9 seconds, or any multiple of seconds, such as three, four, five, six, seven or more seconds.

It is possible that the computer will determine that speech data is received from more than one microphone simultaneously, but will detect the levels of the speech data and determine that the speech is quiet enough that it should not be considered simultaneous speech. This may occur, for example, when speech is detected through a microphone that is adjacent to the speaker's microphone. This may also occur through an omnidirectional microphone that is used to record sound in the entire room.

As noted above, once it is determined that multiple speakers are speaking for more than the predetermined time, a notification is presented to one or more persons, including one or more of the speakers 10, 12, a person operating the apparatus 8 (not shown) and/or another party, such as a judge, a court reporter, or a referee. The alert may take any number of forms from triggering a visual message to the operator (such as lighting a light attached to the microphone), sounding an audible alert from a siren, chime, or other device mounted on or near the microphone, playing a pre-recorded audible message (e.g., “Alert, there are two speakers speaking!”), producing a textual warning on a screen, or any other human-perceptible alert, including without limitation, text message sent to cellular phones, vibrations of cellular phones, notification on an app on computers or cellular phones, etc. Any mechanisms or devices that are able to create such a human-perceptible notifications, or their equivalents, may be the notification means 18.

Preferably there are as many microphones as human speakers. Furthermore, there may be an omnidirectional microphone recording sound from the entire environment (e.g., room), thereby permitting a computer or other logic device to determine, using various forms of data from some or all of the microphones, when more than one speaker is speaking for longer than the predetermined time. Optionally there may be video recording of one or more speakers, and the video data may also optionally be utilized to identify each speaker and determine when there is more than one speaker speaking. If all human speakers are adjacent individual microphones, and all human speakers are video recorded, the data from all inputs may be analyzed by software to determine whether a speaker is speaking for longer than the predetermined time when another speaker is also speaking. A video system may detect sign language or other non-audible communication gestures made by a human speaker that may later, or simultaneously, be translated by software into a transcript. Such non-audible communication may be detected and compared to audible speech to determine whether multiple human speakers are speaking, meaning communicating, simultaneously, even if the communication is not audible.

The apparatus 8 records and analyzes audio input from a single or multiple inputs, such as wireless microphones and cameras, and may analyze video signals that detect sign language made by a speaker. The apparatus processes the audio and video input and stores data related to the recordings, such as how many voices are detected simultaneously, and the time duration of audio segments and/or segments of video detecting sign language being gestured. The apparatus 8 may also identify background noise, parse each audio source/voice into individual audio tracks, and carry out other forms of analysis to determine whether a notification of simultaneous speaking should be given.

The apparatus may use a multitude of methods to differentiate audio sources including, but not limited to, multiple microphones, directional microphones, omnidirectional microphones, directional video cameras, omnidirectional video cameras, voice data analysis, and artificial intelligence. A basic way of differentiating between different speakers is directional microphones assigned to individual speakers. If speaker A has his own directional microphone and speaker B has her own directional microphone, the signal from speaker A's microphone can logically be associated with speaker A's speech, and the signal from speaker B's microphone can logically be associated with speaker B's speech. Thus, the audio signals may be processed by a computer that creates separate recording tracks for speaker A's speech and speaker B's speech. When signals simultaneously occur, the computer may maintain separate tracks, along with assigning times when simultaneous speech is occurring, thereby simplifying manual transcription later. If digital transcription occurs, the transcription software transcribes both tracks and notes in the visual display (computer screen, printed page, etc.) that both speakers were speaking simultaneously. However, by transcribing both tracks, the words of both speaker A and B are presented in the transcription.

This processing of the data may be more complex, and more reliable, when multiple audio sources (individual microphones, omnidirectional microphone receiving all audio in the room) and video sources (individual cameras on each speaker, omnidirectional camera on all speakers) are used. To supplement further, other data-gathering devices (e.g., motion sensors, thermal radiation sensors, etc.) may also be used. Some or all of the data is processed to determine whether and when there are multiple speakers speaking simultaneously. The recording is recorded for real-time or subsequent transcription, and when multiple speakers are detected speaking simultaneously, separate vocal tracks may be made to preserve the best data for real-time or subsequent transcription of the data.

Furthermore, the apparatuses and methods described herein may be used in conjunction with U.S. Pat. No. 8,161,123 to Verona, which is incorporated herein by reference. In this manner, permanent files may be created, and their integrity may be ensured, by associating at least one track, and perhaps multiple tracks, representing the best data available during the event. The above-referenced time-stamped file maintains the integrity of the data for later analysis if there is a dispute about the transcription. Thus, when the transcription occurs real-time (simultaneously as the speaking occurs) or thereafter, if there is ever a question about the transcribed text, the audio and possibly other data are available for further, perhaps more painstaking and detailed, analysis to ensure the integrity of the transcription.

In one example, the apparatus 8 is used during a deposition to maximize the effectiveness of the recording. The operator of the apparatus 8 programs the apparatus 8 to send an alert to notify the operator and/or the participants to only speak one at a time when the apparatus 8 detects more than one voice for more than 2 seconds. The alert minimizes the time when two or more people are speaking, thereby making it easier to understand what each person is saying on the recorded audio.

The apparatus records the raw audio, video and other data, and may create individual recording tracks for each audio source, each of which may record one person's voice, background noise, and other audio received by the microphone. All of the recorded tracks may be used in the process of transcribing the audio manually by a court reporter (or digitally if desired) at the time of, or after, the deposition. This completed data file may be stored and time-stamped. In addition, the invention may provide real-time transcription of the raw audio file and/or any number of the individual recording tracks. The invention may also compare the transcription from the raw audio and the individual tracks to identify potential inaccuracies that need further processing.

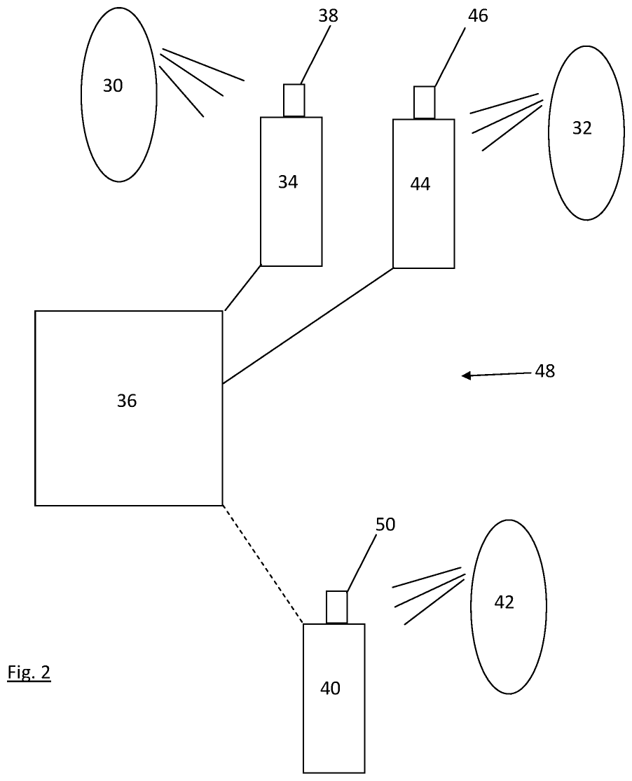

Another apparatus 48 is disclosed herein and shown in FIG. 2 for recording audio and/or video data and transcribing into digital or printed text and includes three microphones 34, 40 and 44, at least one audio recording device 36, and at least one notification means 38, along with two additional notification means 46 and 50. Human speakers 30, 32 and 42 are adjacent components of the apparatus 48. In the example of FIG. 2, the human speakers 30, 32 and 40 speak, thereby creating sound waves that move at least toward the microphones 34, 40 and 44. The microphones receive the sound waves made by the speakers and transduce them into electrical signals or an equivalent form of data. Those signals are transmitted, such as by wire but alternatively wirelessly, to a device 36 that records the data.

It is contemplated to transcribe the speech from each human speaker as it is spoken, and form a textual representation of the spoken words. This may be accomplished by a computer with software that is programmed to carry out the steps described herein, including without limitation the detection of vocal characteristics, the use of video data to the input from either or both of the individual microphones and the omnidirectional microphone. The speaking may, as noted above, be a person gesturing using sign language or any other form of non-audible communication. These steps are to permit the computer to determine when each individual speaker is speaking, as well as to create a textual representation of the speakers' speech. The textual representation may be displayed on a screen, such as a computer screen or television, in one or more rooms where speakers are located. The textual representation may also be stored as a text, image or other computer file.

The device 36, or another device (not shown), may include software and a computer for receiving the data and, in real time, analyzing the data to determine whether more than one speaker is speaking simultaneously. If simultaneous speaking occurs for more than a predetermined amount of time, a notification is given. The predetermined amount of time may be one of the predetermined amounts of time described above.

In the example of FIG. 2, the speaker 42 may be remote from the speakers 30 and 32, such as in a different state, and the microphone 40 may be the microphone of a telephone or a computer. The microphone 40 may connect via the internet to the device 36, or by any other means. Thus, the device 36 may use the data received by the microphones 34, 40 and 44 to determine when there is more than one speaker speaking simultaneously for longer than the predetermined time. If this occurs, one or more of the notification means 38, 46 and 50 alerts the speakers 30, 32 and 42, respectively, of the circumstances. The notification may be by any human-perceived sense, including human-perceivable sound, visual notification, smell, taste or temperature.

As noted above, the term “speech” is audible or non-audible communication created by a human, typically by speaking from his or her mouth, but also by gesturing using sign language.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An apparatus for recording speech coming from two or more human speakers, the apparatus comprising:
(a) at least one microphone adapted to detect speech from the two or more human speakers and convert the speech into a signal;
(b) a recorder for recording the signal;
(c) means for analyzing the signal to detect whether any of the human speakers is speaking simultaneously for longer than a predetermined time; and
(d) a human-perceptible alert that may be triggered when two or more of the human speakers are speaking simultaneously for longer than the predetermined time.

2. The apparatus in accordance with claim 1, wherein the at least one microphone comprises at least two microphones.

3. The apparatus in accordance with claim 1, wherein the human-perceptible alert comprises an audio transducer.

4. An apparatus for recording speech coming from two or more human speakers, the apparatus comprising:
(a) at least one microphone adapted to detect speech from the two or more human speakers and convert the speech into a signal;
(b) a recorder for recording the signal;
(c) a computer configured to analyze the signal to detect whether any of the human speakers is speaking simultaneously for longer than a predetermined time; and
(d) a human-perceptible alert that may be triggered when two or more of the human speakers are speaking simultaneously for longer than the predetermined time.

5. The apparatus in accordance with claim 4, wherein the at least one microphone comprises at least two microphones.

6. The apparatus in accordance with claim 4, wherein the human-perceptible alert comprises an audio transducer.

7. A method of notifying at least one of at least two human speakers of simultaneous speech, the method comprising:
(a) detecting speech from the at least two human speakers;
(b) analyzing the speech to determine whether the speech is simultaneously produced by more than one of the at least two human speakers for longer than a predetermined time; and
(c) producing a human-perceptible alert when the speech is simultaneous for longer than the predetermined time.

8. A method of notifying human speakers of simultaneous speech, the method comprising:
(a) detecting speech from at least two human speakers using at least one microphone that produces an electronic signal transmitted to a recorder;
(b) the recorder recording the electronic signal;
(c) processing the electronic signal into a textual representation of the speech;
(d) analyzing the speech to determine whether the speech is simultaneously produced by two or more human speakers for longer than a predetermined time; and
(e) producing a human-perceptible alert when the speech is simultaneous for longer than a predetermined time.
